(19) United States
(12) Patent Application Publication
(10) Pub. No.: US 2026/0024332 A1
(43) Pub. Date: Jan. 22, 2026

(54) Device and Method for Improving Quality of Audio Captured Corresponding to an Incident

(71) Applicant: MOTOROLA SOLUTIONS, INC., CHICAGO, IL (US)

(72) Inventors: GUY BURKO, HOLON (IL); HAIM KAHLON, SHOHAM (IL); JACOB SHEM TOV, JERUSALEM (IL)

(21) Appl. No.: 18/773,827

(22) Filed: Jul. 16, 2024

(51) Int. Cl. G06V 20/40; G06T 7/70; G10L 25/57; G10L 25/60

(52) U.S. Cl. CPC G06V 20/44; G06T 7/70; G10L 25/57; G10L 25/60

(57) ABSTRACT

A process of improving quality of audio captured corresponding to an incident. An electronic computing device determines that an incident is likely to occur at a particular location within a field of view of a camera when the analysis of the video recordings indicate a repeated pattern of occurrences of the incident at the particular location within the field of view. When the device determines that audio quality of the audio of the video recordings captured corresponding to the particular location is below a predetermined audio quality threshold, the electronic computing device identifies a position or orientation relative to the particular location for placing an external microphone and improving the audio quality of the audio captured corresponding to the particular location. The electronic computing device then provides an electronic notification with a recommendation to place the external microphone at the identified position or orientation relative to the particular location.

### BACKGROUND

Surveillance cameras are widely used by public-safety agencies and enterprises to enhance security and monitor activities. However, surveillance cameras often encounter audio quality issues that can hinder their effectiveness. Common problems include background noise, distortion, and low volume, which can make it difficult to clearly capture and understand conversations or sounds corresponding to the scene captured by the cameras.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system in accordance with some embodiments.

FIG. 2 is a block diagram of an electronic computing device shown in FIG. 1 in accordance with some embodiments.

FIG. 3 illustrates a flowchart of a process for improving quality of audio captured corresponding to an incident in accordance with some embodiments.

FIG. 4 illustrates an example scenario in which the embodiments described herein can be advantageously implemented for improving quality of audio captured corresponding to an incident scene.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

As described above, surveillance cameras are vital for security and investigative purposes, but audio quality can impede their effectiveness. Moreover, surveillance cameras are not only pivotal in real-time observation of events but are also critical during post-event investigations. When investigating incidents, public-safety agencies and enterprises heavily rely on surveillance recordings, but poor audio quality can obscure critical details, such as the tone, words, or intent behind spoken interactions. Furthermore, since microphones used for capturing audio of a recorded scene are integrated with the surveillance camera, the audio captured corresponding to different locations or pixel points within a field of view of the camera may not be consistent. An incident that is captured at a greater distance from the camera may have poorer audio quality compared to an incident recorded closer to the camera. For example, consider a scenario where theft incidents have been occurring near a particular store located in a mall. Assume that surveillance cameras positioned at the mall detect instances of loitering near the end of moving stairs located at the mall, where the loitering events often align with the occurrence of theft incidents. Further, assume that the surveillance cameras have a field of view covering both the front of the store as well as the moving stairs. When the surveillance cameras are positioned at a greater distance from the moving stairs in comparison to the front of the store, it is possible that audio captured by surveillance cameras corresponding to loitering events may have poorer audio quality than audio captured by surveillance cameras corresponding to the front of the store. In such situations, poor audio quality can result in missing essential sounds that might indicate the sequence of events leading to theft incidents or help with identifying potential suspects. Consequently, ensuring high-quality audio capture corresponding to incident recordings is as crucial as video clarity, as both contribute substantially to the accuracy and efficiency of investigative outcomes. Accordingly, there is a need for a technological solution that improves the quality of audio captured corresponding to an incident. There is also a need for a technological solution that improves quality of audio captured from locations that are at a farther distance from a position at which the camera is deployed.

One embodiment provides a method of improving quality of audio captured corresponding to an incident. The method comprises: analyzing, at an electronic computing device, using a video analytics engine, a plurality of video recordings captured corresponding to a field of view of camera; determining, at the electronic computing device, that an incident of interest is likely to occur at a particular location within the field of view of the camera when the analysis of the video recordings indicate a repeated pattern of occurrences of the incident of interest at the particular location within the field of view; determining, at the electronic computing device, audio quality of audio of the video recordings captured corresponding to the particular location within the field of view of the camera; determining, at the electronic computing device, that the audio quality of the audio of the video recordings captured corresponding to the particular location within the field of view of the camera is below a predetermined audio quality threshold; identifying, at the electronic computing device, a position or orientation relative to the particular location, such that, a placement of an external microphone at the identified position or orientation relative to the particular location improves the audio quality of the audio captured corresponding to the particular location to a level that is equal to or above the predetermined audio quality threshold; and providing, at the electronic computing device, an electronic notification with a recommendation to place the external microphone at the identified position or orientation relative to the particular location.

Another embodiment provides an electronic computing device, comprising: a communications interface; and an electronic processor communicatively coupled to the communications interface. The electronic processor is configured to: analyze, using a video analytics engine, a plurality of video recordings captured corresponding to a field of view of camera; determine that an incident of interest is likely to occur at a particular location within the field of view of the camera when the analysis of the video recordings indicate a repeated pattern of occurrences of the incident of interest at the particular location within the field of view; determine audio quality of audio of the video recordings captured corresponding to the particular location within the field of view of the camera; determine that the audio quality of the audio of the video recordings captured corresponding to the particular location within the field of view of the camera is below a predetermined audio quality threshold; identify a position or orientation relative to the particular location, such that, a placement of an external microphone at the identified position or orientation relative to the particular location improves the audio quality of the audio captured corresponding to the particular location to a level that is equal to or above the predetermined audio quality threshold; and provide an electronic notification with a recommendation to place the external microphone at the identified position or orientation relative to the particular location.

Each of the above-mentioned embodiments will be discussed in more detail below, starting with example system and device architectures of the system in which the embodiments may be practiced, followed by an illustration of processing blocks for achieving an improved technical system, method, and device of improving quality of audio captured corresponding to an incident scene. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

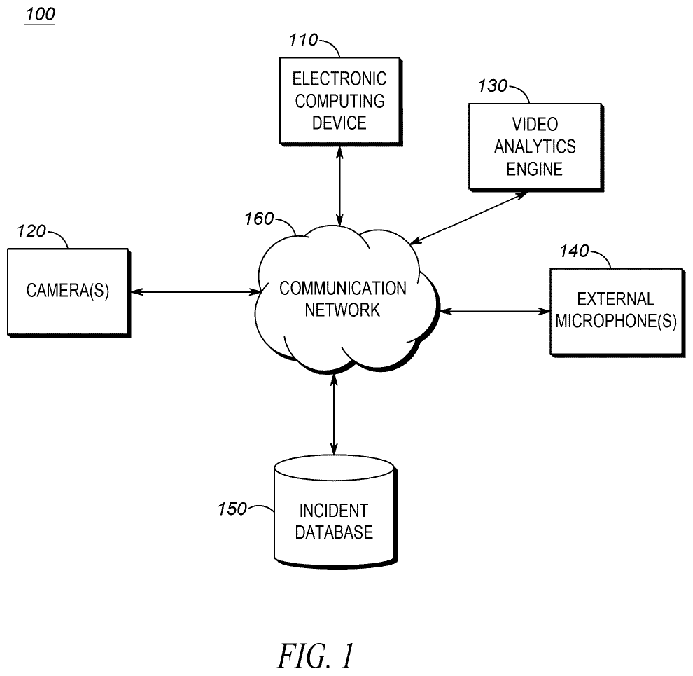

Referring now to the drawings, and in particular FIG. 1, a system 100 is shown including an electronic computing device 110, a camera 120, a video analytics engine 130, an external microphone 140, an incident database 150, and a communication network 160. The electronic computing device 110 is any computing device configured to analyze video recordings captured by the camera 120 for the purpose of improving quality of audio captured corresponding to an incident of interest that is determined to likely occur within a field of view of the camera 120. The electronic computing device 110 may be implemented as a standalone electronic device or alternatively integrated into one or more other devices (e.g., camera) 120 in the system 100. In accordance with some embodiments, the electronic computing device 110 may be authorized by an agency to provide recommendations to place one or more external microphones 140 for improving quality of audio captured corresponding to an incident of interest that is determined to likely occur within the field of view of the camera 120. An agency is an organizational entity that may be responsible for investigating or resolving one or more incidents of interest reported to the agency and/or detected from video recordings captured by the camera 120. In some embodiments, an agency may represent a private enterprise organization such as press, media, utilities, oil/gas, electric, transportation, private security, or other business. In other embodiments, an agency may represent a public organization such as a public-safety agency (e.g., police, fire, emergency medical service), governmental entity (e.g., court, city administration), and the like.

The camera 120 includes any video recording device that is configured to capture a video of a real-world scene corresponding to a field of view of the camera 120. Although only one camera 120 is shown, the system 100 may include any number of cameras 120 that may be deployed in any number of locations. The camera 120 may be owned, controlled, or operated by one or more agencies that may also be responsible for investigating or resolving an incident of interest that may be captured in videos recorded by the camera 120. In accordance with some embodiments, the camera 120 includes a fixed surveillance camera with one or more integrated microphones. However, the embodiments described herein can also be similarly implemented for providing recommendations on placing external microphones (e.g, microphones) when audio quality in video recordings captured by cameras other than fixed surveillance cameras, such as vehicular cameras, mobile cameras, drone cameras, and other portable cameras, is lower than a predetermined audio quality threshold.

The video analytics engine 130 is implemented in computing devices selected from one or more of edge computing devices and cloud computing devices that are configured to run video analytics on video recordings captured by the camera 120. For instance, when implemented at an edge computing device, the video analytics engine 130 may be housed in the same premise (e.g., same building or facility), or otherwise coupled to the same communication network (e.g., a local area network), as the camera 120. Alternatively, the video analytics engine 130 may be implemented on cloud computing devices that may comprise any number of computing devices (including the electronic computing device 110) and servers, and may include any type and number of resources, including resources that facilitate communications with and between servers, storage by the servers that are hosted remotely over one or more communication networks 160. The cloud computing devices may include any resources, services, and/or functionality that can be utilized through an on-demand or subscription service for executing video analytics tasks. In accordance with some embodiments, the electronic computing device 110 may use the video analytics engine 130 to analyze and report an incident of interest detected in video recordings captured by the camera 120. The video analytics engine 130 is configured to receive video recordings captured by the camera 120 and analyze the video recordings to determine properties or characteristics of the captured video streams and/or of persons, objects, or events found in the scene represented by the video recordings. Based on the determinations made, the video analytics engine 130 may further output metadata providing information about the determinations. Examples of determinations made by the video analytics engines may include person, object, or event detection, person, object, or event classification, anomaly detection, facial detection, facial recognition, license plate recognition, identification of objects left behind or removed, business intelligence, and the like. The video analytics engine 130 may include an incident classifier to detect an incident captured in the video stream captured by the camera and to further classify the incident as an incident of interest using one or more predefined rules. As an example, an incident may be classified as an incident of interest when a person of interest (e.g., wanted suspect) is detected in a video recording captured corresponding to a field of view of a camera 120. As another example, an incident may be classified as an incident of interest when an object of interest (e.g., a vehicle displaying a particular license plate number) is detected in a video recording captured corresponding to a field of view of a camera 120. As another example, an incident may be classified as an incident of interest when one or more of the predefined set of events such as shot fired, vehicle collision, loitering, objects left behind, etc., are detected in a video recording captured at a scene. In accordance with some embodiments, the video analytics engine 130 is trained using any appropriate machine learning technique known in the art, including, but not limited to, convolution neural networks, inductive logic programming, support vector machines, random forests, cascade classifiers, decision trees, bayesian networks, sparse dictionaries, and genetic algorithms.

The external microphone 140 includes any standalone audio capturing device i.e., a device that is separate from and remotely located from the camera 120. For example, the external microphone 140 may include an omnidirectional microphone, a directional microphone, or a combination thereof. Although only one external microphone 140 is shown in FIG. 1, the system 100 may include any number of external microphones 140 that are recommended for placement in any number of locations that are monitored by any number of agencies using any number of cameras 120. In accordance with some embodiments, it is possible that an agency may initially not have placed any external microphone 140 in an area monitored using the camera 120 and that the agency may place a new external microphone 140 only in response to receiving a notification from the electronic computing device 110 indicating that the audio quality in video recordings captured corresponding to particular locations (e.g., locations where an incident of interest is determined to likely occur) within the field of view of the camera 120 does not meet an audio quality requirement (e.g., audio quality being lower than a predetermined audio quality threshold) specified by an agency. In other embodiments, the agency may already have an external microphone 140 placed in an area monitored using the camera 120, but the agency may adjust the position or orientation of the previously placed external microphone 140 in response to receiving a notification from the electronic computing device 110 indicating that the audio quality of audio recorded by the previously placed microphone (e.g., external microphone 140) corresponding to particular locations within the field of view of the camera 120 also (i.e., in addition to the audio quality in video recordings captured by the camera 120 not meeting the audio quality requirement) does not meet the audio quality requirement.

The incident database 150 may be implemented using any type of storage device, storage server, storage area network, redundant array of independent discs, cloud storage device, or any type of local or network-accessible data storage device configured to store data records for access by computing devices. In some embodiments, one or more incident databases 150 are implemented in commercial cloud-based storage devices. In some embodiments, the one or more incident databases 150 are housed on suitable on-premise database servers or edge computing devices that may be owned and/or operated by one or more of public-safety or private agencies. The one or more incident databases 150 may be maintained by third parties as well. In accordance with embodiments, the incident database 150 includes electronic records of reported incidents including pending incidents as well as resolved incidents. The incident database 150 stores electronic records in any suitable format or data type, for example, video, image, audio, text, or combination thereof. As an example, the electronic record stored at the incident database 150 may represent an image or a video recorded by a body-worn camera, an audio (e.g., talk group conversations) recorded by a land mobile radio, or text data (e.g., an incident report) entered by a dispatcher. In accordance with some embodiments, the electronic records stored at the incident database 150 may be associated with different agencies (e.g., police department, city administration, court). The video recordings captured by the camera and audio recordings captured by the external microphone 140 may be further stored at the incident database 150 for evidentiary purposes. In accordance with some embodiments, the electronic computing device 110 obtains permission to access and process all or subset of electronic records maintained in one or more incident databases 150 for the purpose of determining whether an incident of interest is likely to occur in a particular location within the field of view of the camera 120.

The electronic computing device 110, the camera 120, the video analytics engine 130, the external microphone 140, and the incident database 150 may each include one or more wired or wireless communication interfaces for communicating with other devices operating in the system 100 via the communication network 160. The communication network(s) 160 may include wireless and/or wired connections. For example, the communication network 160 may be implemented using a wide area network, such as the Internet, a local area network, such as a Wi-Fi network, and personal area or near-field networks, for example a Bluetooth™ network. Portions of the communications network may include a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, a 5G network, and combinations or derivatives thereof.

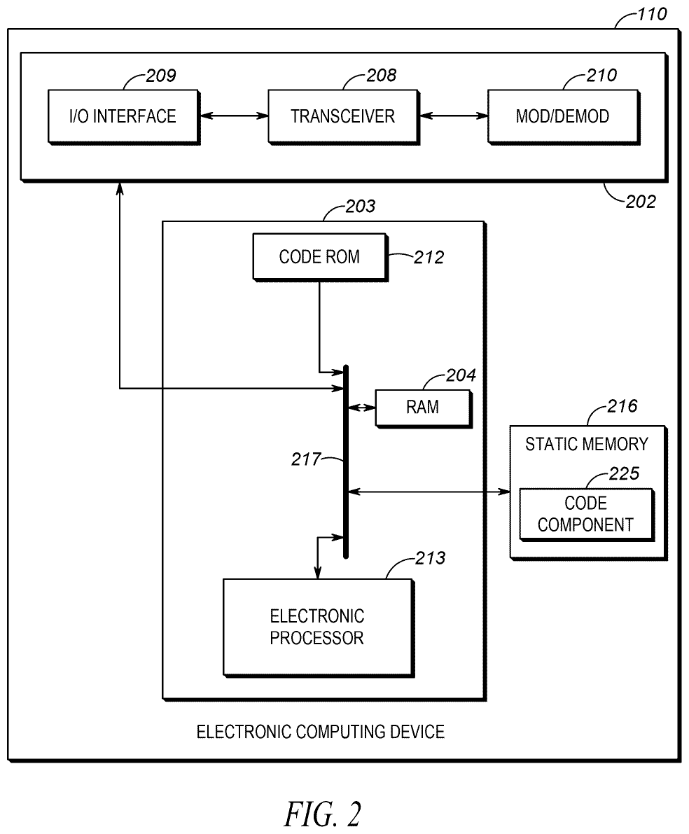

FIG. 2 is an example functional block diagram of an electronic computing device 110 operating within the system 100 in accordance with some embodiments. The electronic computing device 110 may be embodied in computing devices not illustrated in FIG. 1, and/or may be a distributed computing device across two or more of the foregoing (or multiple of a same type of one of the foregoing) and linked via a wired and/or wireless communication link(s). In one embodiment, one or more functions of the electronic computing device 110 can be implemented within the camera 120, the video analytics engine 130, or other devices shown in FIG. 1. While FIG. 2 represents an electronic computing device 110 described above with respect to FIG. 1, the electronic computing device 110 may include fewer or additional components in configurations different from that illustrated in FIG. 2.

As shown in FIG. 2, the electronic computing device 110 includes a communications interface 202 coupled to a common data and address bus 217 of a processing unit 203. The communications interface 202 sends and receives data to and from other devices in the system 100. The communications interface 202 may include one or more wired and/or wireless input/output (I/O) interfaces 209 that are configurable to communicate with other devices in the system 100. For example, the communications interface 202 may include one or more wireless transceivers 208, such as a DMR transceiver, a P25 transceiver, a Bluetooth transceiver, a Wi-Fi transceiver perhaps operating in accordance with an IEEE 802.11 standard (for example, 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network. The communications interface 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

The processing unit 203 may include an encoder/decoder with a code Read Only Memory (ROM) 212 coupled to the common data and address bus 217 for storing data for initializing system components. The processing unit 203 may further include an electronic processor 213 (for example, a microprocessor, a logic circuit, an application-specific integrated circuit, a field-programmable gate array, or another electronic device) coupled, by the common data and address bus 217, to a Random Access Memory (RAM) 204 and a static memory 216. The electronic processor 213 may generate electrical signals and may communicate signals through the communications interface 202.

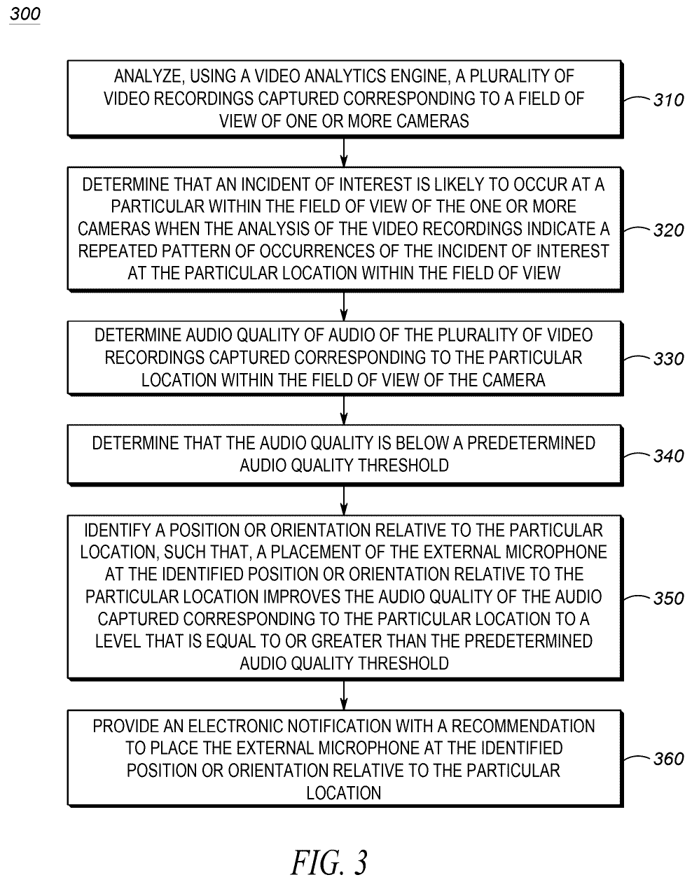

Static memory 216 may store operating code 225 for the electronic processor 213 that, when executed, performs one or more of the blocks set forth in FIG. 3, and the accompanying text(s). The static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, and the like. The static memory 216 may further store information required for the purpose of improving quality of audio captured corresponding to an incident. As an example, the static memory 216 stores video recordings captured by the camera 120 and incident description data (e.g., data indicating detection of an incident of interest with respect to a person or object captured in a video stream) extracted by the video analytics engine 130 based on processing the video recordings captured by the camera 120. The static memory 216 may also store information retrieved from the incident database 150 to enable the electronic computing device 110 to identify a particular location within the field of view of the camera 120 at which an incident of interest is determined to likely occur.

Turning now to FIG. 3, a flowchart diagram illustrates a process 300 for improving quality of audio captured corresponding to an incident. While a particular order of processing steps, message receptions, and/or message transmissions is indicated in FIG. 3 as an example, timing and ordering of such steps, receptions, and transmissions may vary where appropriate without negating the purpose and advantages of the examples set forth in detail throughout the remainder of this disclosure. The electronic computing device 110 shown in FIG. 1 and/or FIG. 2, and embodied as a singular computing device or distributed computing device may execute process 300 via an electronic processor 213.

The electronic computing device 110 may execute the process 300 at power-on, at some predetermined periodic time period thereafter, in response to a trigger raised locally at the electronic computing device 110 via an internal process or via an input interface or in response to a trigger from an external device to which the electronic computing device 110 is communicably coupled, among other possibilities.

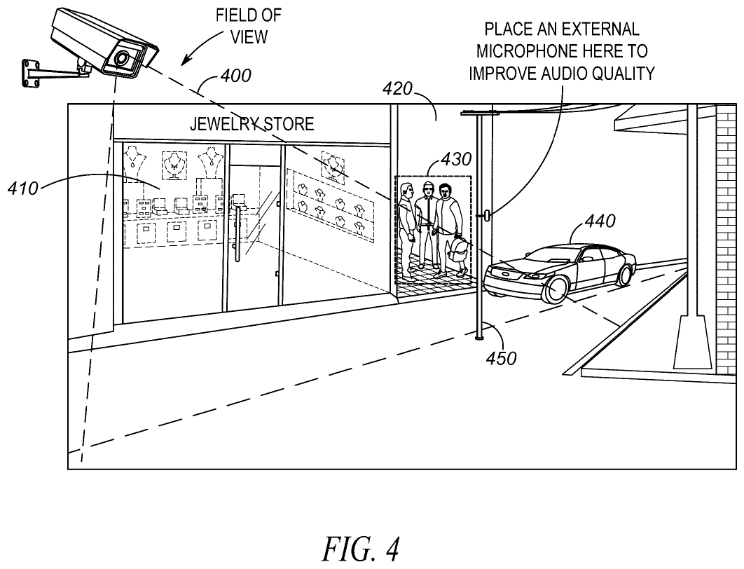

The process 300 of FIG. 3 need not be performed in the exact sequence as shown and likewise various blocks may be performed in different order or alternatively in parallel rather than in sequence. The process 300 may be implemented on variations of the system 100 of FIG. 1 as well. The process 300 is also further described herein with reference to an example scenario illustrated in FIG. 4.

At block 310, the electronic computing device 110 analyzes a plurality of video recordings captured corresponding to a field of view of a camera 120. In one embodiment, the electronic computing device 110 accesses the video recordings captured by the camera 120 from the incident database 150. The electronic computing device 110 may be programmed to periodically retrieve and analyze the video recordings captured corresponding to each area monitored by the camera 120 operated by an agency. In another embodiment, the electronic computing device 110 obtains video recordings directly from the camera 120. In this embodiment, the electronic computing device 110 receives and analyzes video recordings in real-time i.e., as soon as the video is captured by the camera 120. In accordance with some embodiments, the analysis of the video recordings using the video analytics engine 130 may result in detection of one or more incidents of interest occurring within an area monitored by the camera 120. In addition, in some cases, the analysis of the video recordings may result in detection of a repeated pattern of occurrences of incidents, that are same or contextually similar, at a particular location within a field of view.

At block 320, the electronic computing device 110 determines that an incident of interest is likely to occur at a particular location within the field of view of the camera 120 when the analysis of the video recordings indicate a repeated pattern of occurrences of the incident of interest (e.g., loitering) occurring at a particular location within the field of view. As an example, referring to FIG. 4, assume an agency tasked with providing security surveillance for a jewelry store has a surveillance camera mounted near a front door of the store. Further assume the surveillance camera has a wide field of view 400 covering a first particular location 410 including the jewelry store entrance and a second particular location 420 covering a portion of a secluded alleyway located adjacent to the jewelry store. In this example, further assume that the surveillance camera is mounted at a position that is at a greater distance from the second particular location 420 than the first particular location 410. The electronic computing device 110 may determine, based on the analysis of the video recordings captured by the surveillance camera, that there is a repeated pattern of suspicious activities (e.g., loitering) or incidents of interest occurring at the second particular location 420 within the field of view 400 of the surveillance camera 120 that includes the secluded alleyway located adjacent to the jewelry store. In accordance with embodiments, the electronic computing device 110 uses the video analytics engine 130 to analyze the video recordings captured by the camera 120 and further detect suspicious activities or incidents of interest occurring at the second particular location 420 within the field of view of the camera 120. As an example, the video analytics engine 130 may classify an activity detected in a video recording as a suspicious activity when the activity involves a group of persons 430 loitering near the alleyway located adjacent to the jewelry store for longer than a threshold time period. As another example, the video analytics engine 130 may classify an activity detected in a video recording as a suspicious activity when the activity involves a vehicle 440 being idly parked at the corner of the alleyway located adjacent to the jewelry store for longer than a threshold time period. The electronic computing device 110 may determine that an incident of interest is likely to occur at a particular location when same or similar suspicious activities are detected in a number of video recordings (e.g., video recordings captured during different times of the same day or different days) captured by the camera 120. The electronic computing device 110 may use one or more predefined video analytics rules (e.g., generated based on historical incident pattern) to identify that an incident of interest is likely to occur at a particular location based on a repeated occurrence (e.g, more than a predetermined number of times) of suspicious activities (e.g., loitering or idle vehicle parking) detected from video recordings that are captured corresponding to the particular location.

At block 330, the electronic computing device 110 determines audio quality of audio of the video recordings captured corresponding to the particular location (e.g., second particular location 420 shown in FIG. 4) within the field of view of the camera. The audio captured in the video recordings may be captured by an internal microphone (not shown) integrated into the camera 120. In one embodiment, since the incident of interest is likely to occur or originate from particular locations (e.g., second particular location 420 shown in FIG. 4) within the camera's field of view, the electronic computing device 110 estimates audio quality of audio captured corresponding to only particular locations at which the incident of interest is determined to likely occur and not other locations (e.g., first particular location 410 shown in FIG. 4) within the field of view of the camera 120. As an example, referring back to FIG. 4, the electronic computing device 110 separates an audio portion of a video recording captured by the camera into a first audio portion that is captured particularly corresponding to the second particular location 420 (i.e., location covering the secluded alleyway adjacent the jewelry store) within the field of view of the camera 120 and a second audio portion that covers audio captured from other locations such as the first particular location 410 (i.e., location covering the jewelry store entrance) within the field of view of the camera 120. For instance, audio captured from sound sources (e.g., conversations between people) present at the first particular location 410 covering the jewelry store entrance may have less distortion (e.g., due to low background noise) and therefore have better audio quality than audio captured from sound sources (e.g., conversations between people) present at the second location covering the alleyway. Accordingly, in this example, electronic computing determines audio quality of only the relevant audio portion of the video recorded corresponding to the second particular location 420 as the incident of interest or detected suspicious activity is more likely to occur from the second particular location 420. In another embodiment, the electronic computing device 110 may determine audio quality of audio captured corresponding to all locations within the field of view of the camera 120. In this embodiment, the electronic computing device 110 may recommend placement of an external microphone 140 relative to each particular location within the field of view of the camera 120 at which the estimated audio quality is below a predetermined audio quality threshold.

The electronic computing device 110 may use any technique known in the art for determining audio quality of audio in the video recordings that are originating from specific locations within the field of view of the camera 120. As an example, the electronic computing device may examine the bitrate of the audio data captured corresponding to the particular location at which the incident of interest is determined to likely occur, where high bitrates may indicate better audio quality. As another example, the electronic computing device 110 may measure the ratio of the desired audio signal to the background noise present in the audio data captured corresponding to the particular location, where the higher signal-to-noise ratio may indicate better audio quality. In one embodiment, the electronic computing device 110 estimates an audio quality score by aggregating the quality of audio recorded from portions of different video recordings capturing the particular location of the field of view of the camera 120. Regardless of the techniques used for determining the audio quality, the electronic computing device 110 determines whether the audio quality of the audio of the video recordings captured corresponding to the particular location within the field of view of the camera is below a predetermined audio quality threshold. The predetermined audio quality threshold may be determined either based on a user input or based on data regarding minimum audio quality that is required for satisfying evidentiary requirements.

If the audio quality is not below the predetermined audio quality threshold, then the electronic computing device 110 determines that the audio quality of audio captured in video recordings corresponding to the particular location (e.g., second particular location 420 covering the secluded alleyway adjacent the jewelry store) satisfies the evidentiary or investigative requirements of an agency. In this case, the electronic computing device 110 may optionally provide an electronic notification to an authorized user (e.g., video surveillance operator) associated with the agency indicating that the audio quality of audio recorded by the surveillance camera 120 is sufficient for satisfying the evidentiary or investigative requirements of the agency and that no external or standalone microphone is required at this time for improving audio quality of audio that may originate from the particular location within the field of view of the camera 120. Furthermore, in this case, the electronic computing device 110 does not execute the functions described with reference to blocks 350 and 360.

On the other hand, as described at block 340, when the electronic computing device 110 determines that the audio quality of the audio of the video recordings captured corresponding to the particular location within the field of view of the camera 120 is below the predetermined audio quality threshold, the electronic computing device 110 determines that there is a need to place an external microphone 140 for improving audio quality of audio captured corresponding to the particular location and further proceeds to execute the functions described with reference to blocks 350 and 360.

At block 350, the electronic computing device 110 identifies a position or orientation relative to the particular location (e.g., second particular location 420 shown in FIG. 4), such that, a placement of the external microphone 140 at the identified position or orientation relative to the particular location improves the audio quality of the audio captured corresponding to the particular location to a level that is equal to or above the predetermined threshold. The electronic computing device 110 identifies a position or orientation for placing a new external microphone 140 or for adjusting a previously placed external microphone 140 relative to the particular location in order to improve audio quality of audio captured from sound sources present at the particular location. In accordance with some embodiments, the electronic computing device 110 identifies a position or orientation for placement of an external microphone 140 by considering one or more of the following factors that may affect the audio quality of audio captured at the particular location: (i) a distance between a suitable mounting object or surface for placement of the external microphone 140 and the particular location, where the placement of an external microphone 140 too far from the particular location may weaken the audio signal, whereas the placement of the external microphone 140 too close to the particular location may result in distorted audio, (ii) types of external microphones available for placement including its directional pattern and sensitivity, (iii) background noise reduction capability of the external microphone 140 to be selected for placement, (iv) environmental conditions near the particular location that may contribute to reflections, echoes, or reverberation, and (iv) type or severity of incident of interest, where different types or severity of incident may have different evidentiary purpose or policy requiring a different audio quality standard or threshold. The factors listed above are provided only as examples and that other factors similarly impacting sound quality may be similarly used by the electronic computing device 110 to identify a position or orientation at which the placement of the external microphone 140 would improve audio quality to a level equal to or above the predetermined audio quality threshold.

In one embodiment, when the electronic computing device 110 determines that there is a need to place the external microphone 140 for improving audio quality of audio captured at the particular location where the incident of interest is likely to occur, the electronic computing device 110 uses the video analytics engine 130 to analyze the video recordings captured corresponding to the particular location and to further identify if there is any object appearing within the field of view of the camera 120 where the object provides a suitable mounting surface for the external microphone. The electronic computing device 110 then determines if a distance between the object to be used for mounting the external microphone 140 and the particular location is within a range of distance threshold. The range of distance threshold may be defined based on user input or historical data identifying a distance that is neither too close nor too far to result in poor audio quality (i.e., lower than the predetermined audio quality threshold). In other words, the electronic computing device 110 may select the object as a suitable mounting surface for placement of the external microphone 140 when the distance between the object and the particular location is within the range of distance threshold. As an example, referring to FIG. 4, the electronic computing device 110 may identify an electrical pole 450 located in proximity to the second particular location 420 covering the secluded alleyway as providing a suitable mounting surface for an external microphone 140.

In one embodiment, the electronic computing device 110 selects, from a list of available external microphones, one or more external microphones that would improve the audio quality of audio captured from the particular location based on the directional pattern, sensitivity, or other configurations that may affect the audio quality of audio captured by the external microphone 140. As an example, if the electronic computing device 110 determines that there are multiple locations where one or more same or different types of incidents of interest are likely to occur, then the electronic computing device 110 may determine an optimal location (e.g., a location that is at about an equal distance from each of the multiple locations where incidents of interest are likely to occur) at which to position or orient the external microphone 140. In addition, the electronic computing device 110 may determine that an omnidirectional microphone, which is capable of capturing sound equally from all directions, may be more efficient for improving audio quality of audio captured from multiple locations instead of microphones that are configured to capture sound primarily from one direction. On the other hand, when there is only one particular location within the field of view of the camera 120 where the incident of interest is likely to occur, the electronic computing device 110 may determine that a microphone, that is more sensitive to sound coming from a direction of that particular location while attenuating or rejecting sound from other directions, is more suitable for improving audio quality of audio captured from the particular location.

In one embodiment, if the electronic computing device 110 determines if there are external microphones 140 (i.e., microphones that are separate from and located remotely from microphones integrated into the camera 120) previously placed relative to the particular location (e.g., second particular location shown in FIG. 4), where the incident of interest is determined to likely occur, then the electronic computing device 110 further determines if the audio quality of audio captured by the previously placed external microphone is below the predetermined audio quality threshold. If the audio quality is below the predetermined audio quality threshold, then the electronic computing device 110 determines that there is a need to either adjust the position or orientation of the previously placed external microphone and/or there is a need to place a second external microphone 140 for improving audio quality of audio captured corresponding to the particular location to a level equal to or above the predetermined audio quality threshold. The electronic computing device 110 may similarly identify a new position or orientation of the previously placed microphone as a function of one or more of: (i) a distance between a current mounting surface or object at which the external microphone 140 is previously placed and the particular location, (ii) directional pattern or sensitivity of the previously placed external microphone, (iii) background noise reduction capability of the previously placed microphone, (iv) environmental conditions near the particular location that may contribute to reflections, echoes, or reverberation, and (iv) type or severity of incident of interest or evidentiary purpose.

At block 360, the electronic computing device provides an electronic notification with a recommendation to place the external microphone 140 at the identified position or orientation relative to the particular location (e.g., second particular location 420 shown in FIG. 4). The electronic notification may also include information indicating if there is a need to adjust a position or orientation of a previously placed external microphone or if there is a need to deploy one or more new external microphones 140 for improving audio quality of audio captured from the particular location where the incident of interest is likely to occur. The electronic notification may be provided in any suitable format including text, audio, image, or combination thereof, via a suitable visual and/or audio output device (e.g., electronic display and/or speaker) that may be operated by a user authorized with an agency that has requested the electronic computing device 110 to provide a service to improve quality of audio captured corresponding to an incident that may occur in an area monitored by the agency. In one example, the electronic notification may further include information about an object (e.g., detected using the video analytics engine) located within a field of view of the camera 120, where the object provides a suitable mounting surface for the placement of the external microphone. In addition to providing information regarding the position, orientation, or mounting surface or object for placement of the external microphone, the information may also include recommended configurations (e.g., directionality or sensitivity configurations for the external microphone) for placement of the external microphone for further improving audio quality of audio captured from the particular location. In accordance with some embodiments, the electronic computing device 110 may provide an image of a scene that is captured corresponding to the field of view of the camera 120 and may further highlight a particular object or area within the camera's field of view at which the external microphone 140 is recommended to be placed for improving audio quality of audio captured from the particular location. In one embodiment, an augmented reality (AR) view of the scene may be displayed via an AR display to provide information about the position, orientation, or mounting surface or object at which a new external microphone is recommended to be placed for improving audio quality of audio captured from the particular location where the incident is determined likely to occur. As an example, referring to FIG. 4, the electronic computing device 110 may highlight the electrical pole 450 that is located in proximity to the second particular location 420 covering the alleyway adjacent the jewelry store as providing a suitable mounting surface for placing a new external microphone 140 for improving audio quality of audio captured from the second particular location 420 within the field of view of the camera 120.

In accordance with embodiments, the electronic computing device 110 continues to analyze additional video recordings captured corresponding to a field of view of the one or cameras 120 and further provides updated recommendations regarding adjusting the position or orientation of previously placed external microphones or for placing new external microphones 140 for improving audio quality of audio captured at the particular locations where the incident(s) of interest are likely to occur. In one embodiment, the electronic computing device 110 analyzes, using the video analytics engine 130, a new video recording (i.e., not including the video recordings previously analyzed at block 310) captured by the camera 120. The electronic computing device 110 detects a new occurrence of events that are similar to or contextually related to the incident of interest (e.g., loitering) detected at block 320. In response to detecting the new occurrence of the incident of interest, the electronic computing device 110 determines whether an external microphone 140 was already placed at the identified position or orientation in accordance with the recommendation previously provided by the electronic computing device 110 at block 360. If the electronic computing device 110 has access to information indicating that an external microphone 140 was placed at the identified position or orientation in accordance with the previously provided recommendation, then the electronic computing device 110 retrieves an audio-only recording captured by the external microphone 140 at the same time when the new video recording was captured by the camera 120. Subsequent to retrieving the audio recording captured by the external microphone, the electronic computing device 110 links the new video recording captured by the one or cameras 120 and the audio recordings captured by the microphone to a common incident identifier identifying the new occurrence of the incident of interest. Linking the new video recording to the audio recording ensures that users authorized by the agency are able to search (e.g., via a query identifying the common incident identifier) and access audio (i.e., audio recorded with the external microphone) captured corresponding to a detected incident of interest at better audio quality (i.e., audio quality at a level equal or above the predetermined audio quality threshold) than the audio included in the video recordings captured by the camera 120. In one embodiment, as an alternative to or in addition to linking the new video recording with the audio recording captured by the external microphone, the electronic computing device 110 further synchronizes the new video recording captured by the camera 120 and the audio captured by the external microphones. The synchronization may result in merging the video recording and the corresponding audio recording into a single file such that each video segment in the video recording is time aligned with the respective audio segment in the audio recording for seamless playback. The synchronized recording may then be linked to the common incident identifier associated with the incident of interest and further stored at the incident database 150.

If the electronic computing device 110 determines, in response to detecting the new occurrence of the incident of interest at the particular location within the field of view of the camera 120, that the external microphone 140 is not placed at the determined position or orientation relative to the particular location at the time the new video recording was captured by the camera 120, the electronic computing device 110 then provides another notification to remind a user authorized with an agency to place an external microphone 140 at the identified position or orientation relative to the particular location in accordance with the recommendation previously provided to the user at block 360.

In accordance with some embodiments, the electronic computing device 110 continuously or periodically verifies if there has been an improvement in the audio quality of audio captured from particular locations (e.g., second particular location 420 covering the secluded alleyway adjacent the jewelry store shown in FIG. 4) within the camera's field of view where incidents of interest are likely to occur. If the electronic computing device 110 determines that the audio quality of audio captured from the particular location is below the predetermined audio quality threshold even after the placement of the external microphone 140 in accordance with the recommended position or orientation relative to the particular location, then the electronic computing device 110 determines that there is a need to either adjust the current position or orientation of the previously placed external microphone or to place a second external microphone at another identified position or orientation relative to the particular location for improving audio quality of audio captured corresponding to the particular location to a level equal to or greater than the predetermined audio quality threshold. The electronic computing device 110 then provides another electronic notification with a recommendation to either adjust the position or orientation of the previously placed external microphone or to place a second external microphone at the another identified position or orientation (e.g., identified in accordance with block 350) relative to the particular location.

In accordance with some embodiments, the electronic computing device 110 may determine multiple different incidents of interest each occurring at a different location within the field of view of the same camera. As an example, consider a scenario where a repeated pattern of car accidents are detected near a first particular location covering a traffic intersection within a field of view of the camera 120 that also includes a second particular location covering a bus station where a repeated pattern of robbery incidents are detected. In such scenarios when there are multiple incidents of interest each occurring in different particular locations of the camera's field of view, the electronic computing device 110 first determines whether an external microphone 140 already placed relative to a first particular location (i.e., a location within the camera's field of view where a first incident of interest such as the car accidents are likely to occur) is sufficient to capture audio from a second particular location (i.e., a location within the camera's field of view where a second incident of interest such as robbery incidents are likely to occur) at an audio quality that is equal to or greater than the predetermined audio quality threshold. If the audio quality of audio captured from the second particular location is equal to or greater than the predetermined audio quality threshold, then the electronic computing device 110 may refrain from recommending placement of an additional external microphone for improving audio quality of audio captured from the second particular location. Optionally, the electronic computing device 110 may also provide an electronic notification to a user authorized with the agency to indicate that the external microphone 140 placed relative to the first particular location is sufficient for capturing audio from the second particular location while meeting the audio quality requirements of the agency. On the other hand, if the electronic computing device 110 determines that the audio quality of audio captured from the second particular location is below the predetermined audio quality threshold, then the electronic computing device 110 determines that there is a need to either adjust the position or orientation of the external microphone 140 relative to both the particular location (e.g., traffic intersection) and the second particular location (e.g., bus station) or to place a second external microphone at another identified position or orientation relative to the second particular location for improving audio quality of audio captured corresponding to both the particular location and the second particular location to a level equal to or greater than the predetermined audio quality threshold. Then the electronic computing device 110 provides another notification with a recommendation to either adjust the position or orientation of the external microphone 140 or to place a second external microphone at the another identified position or orientation relative to the particular location.

In accordance with some embodiments, the electronic computing device 110 determines that suspicious activities (e.g., loitering) detected at a particular location within a field of view of the camera 120 are related to an incident (e.g., theft) that was previously reported (e.g., via an emergency call made to a public safety answering point) at another location within or outside of the field of view of the camera 120. In response, the electronic computing device 110 executes the process 300 to similarly recommend a placement of an external microphone 140 at an identified position or orientation for improving audio quality of audio captured from the particular location within the field of view of the camera 120. As an example, assume a theft incident was reported at the jewelry store shown in FIG. 4 a few weeks ago. Further assume the video recordings captured by the camera 120 one day prior to the theft incident indicate a group of persons 430 loitering near the secluded alleyway. In this case, the electronic computing device 110 may determine that the secluded alleyway adjacent the jewelry store is an area of interest for surveillance purposes based on the correlation between the loitering event detected prior to the theft incident and the actual theft incident occurring on a day after the loitering event. Accordingly, the electronic computing device 110 may recommend placing an external microphone 140 in proximity to the second particular location 420 within the camera's field of view covering the secluded alleyway adjacent the jewelry store.

As should be apparent from this detailed description, the operations and functions of the computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of improving quality of audio captured corresponding to an incident scene, the method comprising;
analyzing, at an electronic computing device, using a video analytics engine, a plurality of video recordings captured corresponding to a field of view of a camera;
determining, at the electronic computing device, that an incident of interest is likely to occur at a particular location within the field of view of the camera when the analysis of the video recordings indicate a repeated pattern of occurrences of the incident of interest at the particular location within the field of view;
determining, at the electronic computing device, audio quality of audio of the video recordings captured corresponding to the particular location within the field of view of the camera;
determining, at the electronic computing device, that the audio quality of the audio of the video recordings captured corresponding to the particular location within the field of view of the camera is below a predetermined audio quality threshold;
identifying, at the electronic computing device, a position or orientation relative to the particular location, such that, a placement of an external microphone at the identified position or orientation relative to the particular location improves the audio quality of the audio captured corresponding to the particular location to a level that is equal to or above the predetermined audio quality threshold; and
providing, at the electronic computing device, an electronic notification with a recommendation to place the external microphone at the identified position or orientation relative to the particular location.

2. The method of claim 1, further comprising:
analyzing, at the electronic computing device, using the video analytics engine, a new video recording captured by the camera;
detecting, at the electronic computing device, a new occurrence of the incident of interest at the particular location within the field of view of the camera based on the analysis of the new video recording;
determining, at the electronic computing device, whether the external microphone was placed at the identified position or orientation relative to the particular location at the time the new video recording was captured by the camera;
responsive to determining that the external microphone was placed at the determined position or orientation relative to the particular location at the time the new video recording was captured by the camera, retrieving, at the electronic computing device, an audio recording captured by the external microphone at the time the new video recording was captured by the camera; and
linking the new video recording captured by the camera and the audio recording captured by the external microphone to a common incident identifier identifying the new occurrence of the incident of interest.

3. The method of claim 2, further comprising:
synchronizing the new video recording captured by the camera and the audio captured by the external microphone; and
storing the synchronized new video recording and the audio at an incident database.

4. The method of claim 2, further comprising:
responsive to detecting the new occurrence of the incident of interest at the particular location within the field of view of the camera and further responsive to determining that the external microphone was not placed at the determined position or orientation relative to the particular location at the time the new video recording was captured by the camera, providing, at the electronic computing device, another notification with the recommendation to place the external microphone at the identified position or orientation relative to the particular location.

5. The method of claim 2, further comprising:
determining, at the electronic computing device, audio quality of the audio recording captured by the external microphone;
determining, at the electronic computing device, that the audio quality of audio recording captured by the external microphone is below the predetermined audio quality threshold;
determining, at the electronic computing device, based on the audio quality of the audio recording captured by the external microphone being below the predetermined audio quality threshold, that there is a need to either adjust the position or orientation of the external microphone or to place a second external microphone at another identified position or orientation relative to the particular location for improving audio quality of audio captured corresponding to the particular location to a level equal to or above the predetermined audio quality threshold; and
providing, at the electronic computing device, a second electronic notification with a recommendation to either adjust the position or orientation of the external microphone or to place the second external microphone at the another identified position or orientation relative to the particular location.

6. The method of claim 1, further comprising:
determining, at the electronic computing device, that a second incident of interest is likely to occur in a second particular location within the field of view of the camera when the analysis of the video recordings indicate a repeated pattern of occurrences of the second incident of interest at the second particular location within the field of view;
determining, at the electronic computing device, audio quality of audio of the plurality of video recordings captured corresponding to the second particular location within the field of view of the camera;
determining, at the electronic computing device, that the audio quality of the audio of the video recordings captured corresponding to the second particular location within the field of view of the camera is below a predetermined audio quality threshold;
determining, at the electronic computing device, based on the audio quality being below the predetermined audio quality threshold, that there is a need to either adjust the position or orientation of the external microphone relative to both the particular location and the second particular location or to place a second external microphone at another identified position or orientation relative to the second particular location for improving audio quality of audio captured corresponding to both the particular location and the second particular location to a level equal to or above the predetermined audio quality threshold;
providing, at the electronic computing device, a second notification with a recommendation to either adjust the position or orientation of the external microphone or to place a second external microphone at the another identified position or orientation relative to the particular location.

7. The method of claim 1, further comprising:
determining, at the electronic computing device, based on the audio quality being below the predetermined audio quality threshold, that there is a need to place the external microphone for improving audio quality of audio captured corresponding to the particular location where the incident of interest is likely to occur;

8. The method of claim 7, further comprising:
responsive to determining that there is a need to place the external microphone for improving audio quality of audio captured corresponding to the particular location where the incident of interest is likely to occur, analyzing the plurality of video recordings captured by the camera to identify an object appearing within the field of view of the camera where the object provides a suitable mounting surface for the external microphone; and
including information in the electronic notification indicating that the identified object is suitable for mounting the external microphone.

9. An electronic computing device, comprising:
a communications interface; and
an electronic processor communicatively coupled to the communications interface, the electronic processor configured to:
analyze, using a video analytics engine, a plurality of video recordings captured corresponding to a field of view of camera;
determine that an incident of interest is likely to occur at a particular location within the field of view of the camera when the analysis of the video recordings indicate a repeated pattern of occurrences of the incident of interest at the particular location within the field of view;
determine audio quality of audio of the video recordings captured corresponding to the particular location within the field of view of the camera;
determine that the audio quality of the audio of the video recordings captured corresponding to the particular location within the field of view of the camera is below a predetermined audio quality threshold;
identify a position or orientation relative to the particular location, such that, a placement of an external microphone at the identified position or orientation relative to the particular location improves the audio quality of the audio captured corresponding to the particular location to a level that is equal to or above the predetermined audio quality threshold; and
provide an electronic notification with a recommendation to place the external microphone at the identified position or orientation relative to the particular location.

10. The electronic computing device of claim 9, wherein the electronic processor is configured to:
analyze, using the video analytics engine, a new video recording captured by the camera;
detect a new occurrence of the incident of interest at the particular location within the field of view of the camera based on the analysis of the new video recording;
determine whether the external microphone was placed at the identified position or orientation relative to the particular location at the time the new video recording was captured by the camera;
responsive to determining that the external microphone was placed at the determined position or orientation relative to the particular location at the time the new video recording was captured by the camera, retrieve an audio recording captured by the external microphone at the time the new video recording was captured by the camera; and
link the new video recording captured by the camera and the audio recording captured by the external microphone to a common incident identifier identifying the new occurrence of the incident of interest.

11. The electronic computing device of claim 10, wherein the electronic processor is configured to:
synchronize the new video recording captured by the camera and the audio captured by the external microphone; and
store the synchronized new video recording and the audio at an incident database.

12. The electronic computing device of claim 10, wherein the electronic processor is configured to:
responsive to detecting the new occurrence of the incident of interest at the particular location within the field of view of the camera and further responsive to determining that the external microphone was not placed at the determined position or orientation relative to the particular location at the time the new video recording was captured by the camera, provide, at the electronic computing device, another notification with the recommendation to place the external microphone at the identified position or orientation relative to the particular location.

13. The electronic computing device of claim 10, wherein the electronic processor is configured to:
determine audio quality of the audio recording captured by the external microphone;
determine that the audio quality of audio recording captured by the external microphone is below the predetermined audio quality threshold;
determine, based on the audio quality of the audio recording captured by the external microphone being below the predetermined audio quality threshold, that there is a need to either adjust the position or orientation of the external microphone or to place a second external microphone at another identified position or orientation relative to the particular location for improving audio quality of audio captured corresponding to the particular location to a level equal to or above the predetermined audio quality threshold; and
provide a second electronic notification with a recommendation to either adjust the position or orientation of the external microphone or to place the second external microphone at the another identified position or orientation relative to the particular location.

14. The electronic computing device of claim 10, wherein the electronic processor is configured to:
determine that a second incident of interest is likely to occur in a second particular location within the field of view of the camera when the analysis of the video recordings indicate a repeated pattern of occurrences of the second incident of interest at the second particular location within the field of view;
determine audio quality of audio of the plurality of video recordings captured corresponding to the second particular location within the field of view of the camera;
determine that the audio quality of the audio of the video recordings captured corresponding to the second particular location within the field of view of the camera is below a predetermined audio quality threshold;
determine, based on the audio quality being below the predetermined audio quality threshold, that there is a need to either adjust the position or orientation of the external microphone relative to both the particular location and the second particular location or to place a second external microphone at another identified position or orientation relative to the second particular location for improving audio quality of audio captured corresponding to both the particular location and the second particular location to a level equal to or above the predetermined audio quality threshold; and
provide a second notification with a recommendation to either adjust the position or orientation of the external microphone or to place a second external microphone at the another identified position or orientation relative to the particular location.

15. The electronic computing device of claim 10, wherein the electronic processor is configured to:
determine, based on the audio quality being below the predetermined audio quality threshold, that there is a need to place the external microphone for improving audio quality of audio captured corresponding to the particular location where the incident of interest is likely to occur.

16. The electronic computing device of claim 10, wherein the electronic processor is configured to:
responsive to determining that there is a need to place the external microphone for improving audio quality of audio captured corresponding to the particular location where the incident of interest is likely to occur, analyzing the plurality of video recordings captured by the camera to identify an object appearing within the field of view of the camera where the object provides a suitable mounting surface for the external microphone; and
including information in the electronic notification indicating that the identified object is suitable for mounting the external microphone.
